(19) United States
(12) Patent Application Publication
(10) Pub. No.: US 2013/0302712 A1
(43) Pub. Date: Nov. 14, 2013

(54) FUEL-CELL STACK COMPRISING A STACK OF CELLS AND BIPOLAR CONDUCTIVE PLATES

(71) Applicants: Xavier Glipa, Verneuil Sur Siene (FR); Jean-Francois Ranjard, Versailles (FR); Eric Pinton, Echirolles (FR); Jean-Philippe Poirot Crouvezier, Saint-Georges de Commiers (FR); Sylvie Begot, Chaux (FR); Fabien Harel, Giromagny (FR); Jean-Marc Le Canut, Belfort (FR)

(72) Inventors: Xavier Glipa, Verneuil Sur Siene (FR); Jean-Francois Ranjard, Versailles (FR); Eric Pinton, Echirolles (FR); Jean-Philippe Poirot Crouvezier, Saint-Georges de Commiers (FR); Sylvie Begot, Chaux (FR); Fabien Harel, Giromagny (FR); Jean-Marc Le Canut, Belfort (FR)

(73) Assignee: Commissariat A L'Energie Atomique et Aux Energies Alternatives, Paris (FR)

(21) Appl. No.: 13/981,115

(22) PCT Filed: Mar. 29, 2012
(86) PCT No.: PCT/FR12/50671

§ 371 Date: Jul. 23, 2013

(30) Foreign Application Priority Data
Mar. 30, 2011 (FR) 11 52 643

(51) Int. Cl. H01M 8/04

(52) U.S. Cl. CPC H01M 8/04074
USPC 429/435

(57) ABSTRACT

A fuel-cell stack including a stack of fuel cells with intermediate conductive bipolar plates. The bipolar plates include internal flow channels for flow of a heat-transfer fluid. The channels are connected to a circuit of a cooling system. Only some of the bipolar plates include internal flow channels that are temporarily or permanently not in service.

### FIELD OF THE INVENTION

The present invention relates to a fuel-cell stack comprising a cooling system using a heat-transfer fluid, and also relates to a generator and a motor vehicle equipped with this type of fuel-cell stack.

### BACKGROUND

Fuel-cell stacks are developed in particular to equip vehicles to replace heat engines, so as to improve the energy output and reduce polluting gas emissions.

Fuel-cell stacks generally include a stack of elementary cells comprising two electrodes separated by an electrolyte, connected to each other by conductive bipolar plates including internal ducts to provide said electrodes with the products necessary for the reaction, and channels for flow of a heat-transfer fluid.

The electrochemical reactions that occur in contact with the electrodes generate electrical current and produce water, while giving off heat energy that heats the various components.

To operate correctly, the fuel-cell stacks must be at a certain temperature comprised between 60 and 800° C., depending on the type. The heat given off by the beginning of the reactions, when the stack is cold, serves first to heat the cells to bring them to the desired operating temperature.

To regulate the temperature of the cells, the heat-transfer fluid flowed by a pump takes calories from said cells when it comes into contact therewith while heating up, said calories then being delivered to a heat exchanger to cool the fluid, in particular by exchange with the ambient air.

One problem that arises in the case of starting a fuel-cell stack that is at a temperature below 0° C. is that the water produced by the electrochemical reaction risks freezing as long as that temperature is below the 0° C. threshold. The fuel-cell stack then can no longer operate correctly, and risks being destroyed.

To resolve this problem, one known cooling system, in particular presented by document EP-A1-0074701, includes a cooling circuit comprising a first flow loop having a heat exchanger and a pump discharging in one direction, and the second flow loop that passes through the cells. The two flow loops intersect in a single point, at a four-way valve comprising two positions that makes it possible, by exchanging those positions, to alternate the flow direction of the fluid in the fuel-cell stack.

It is thus possible, when cold, by closely alternating the flow direction of the fluid in the fuel-cell stack, to limit the same fluid volume passing through the bipolar plates in either direction, to obtain homogenization of the temperature of the cells, as well as a concentration of the heat that remains in the cells to heat the more quickly. It is possible to perform a startup and temperature increase of the fuel-cell stack more quickly, in particular to reach the temperature of 0° C. quickly.

However, the overall heat mass to be heated, in particular comprising all of the cells, the bipolar plates and the fluid contained in those plates, remains significant, and the temperature increase time may be too long. The fluid volume flowing in the fuel-cell stack may also be too high.

### SUMMARY OF THE INVENTION

The present invention aims in particular to avoid these drawbacks of the prior art, by proposing a fuel-cell stack whereof the temperature can increase more quickly.

To that end, it proposes a fuel-cell stack including a stack of cells with intermediate conductive bipolar plates, the bipolar plates including internal channels for flowing a heat-transfer fluid, which are connected to a circuit of a cooling system, characterized in that some of the bipolar plates include, with respect to the other plates, internal flow channels that are temporarily or permanently not in service, or that are absent.

One advantage of the fuel-cell stack according to the invention is that it is in particular possible in the zones of that cell heating less and requiring less cooling, to limit the heat mass of those areas without channels, or to limit the flow of fluid with channels that are not in service.

The fuel-cell stack according to the invention may further comprise one or more of the following features, which may be combined with each other.

Advantageously, the bipolar plates comprising channels that are not in service are made from other bipolar plates, the inlet of the internal channels being closed by permanent or temporary closing means.

The permanent sealing means may include nipping the metal forming the inlet of the channels, a drop of glue or a weld.

Advantageously, the internal volume of the channels is placed in a vacuum, or filled with a gas or another material having a low heat capacity.

Furthermore, the bipolar plates that do not have channels may be designed specifically for that purpose, and comprise a reduced heat mass with respect to other plates including channels.

Alternatively, the bipolar plates comprising channels that are not in service may include a temporary closing means having at least one automatic operation means as a function of the temperature of that plate.

These bipolar plates may also include a temporary closing means that is controlled, such as a micro-actuator.

Advantageously, in its end zones, the fuel-cell stack includes a greater density of bipolar plates comprising internal flow channels that are not in service, or internal flow channels are absent.

The invention also relates to a generator having a fuel-cell stack, which includes any one of the preceding features.

The invention additionally relates to an electric vehicle having a fuel-cell stack delivering electrical current used for traction, said fuel-cell stack including any one of the preceding features.

The invention additionally relates to an electric vehicle having a fuel-cell stack delivering electrical current used for traction, comprising the preceding feature.

### BRIEF DESCRIPTION OF DRAWING FIGURES

The invention will be better understood, and other features and advantages thereof will appear more clearly, upon reading the description below provided as an example, in reference to the appended drawings, in which:

FIG. 1 shows different temperature zones of the fuel-cell stack according to the prior art, during operation;

FIG. 2 shows a bipolar plate for a fuel-cell stack according to the invention;

FIG. 3 shows a detail of said bipolar plates;

FIG. 4 shows a detail of a bipolar plate according to the invention, made according to one alternative;

FIG. 5 is a graph showing, as a function of time, the evolution of the voltages and powers of the different cells of a fuel-cell stack according to the invention; and

FIG. 6 is a graph showing the evolution of the voltages and powers of the various cells of the fuel-cell stack according to the prior art.

### DETAILED DESCRIPTION

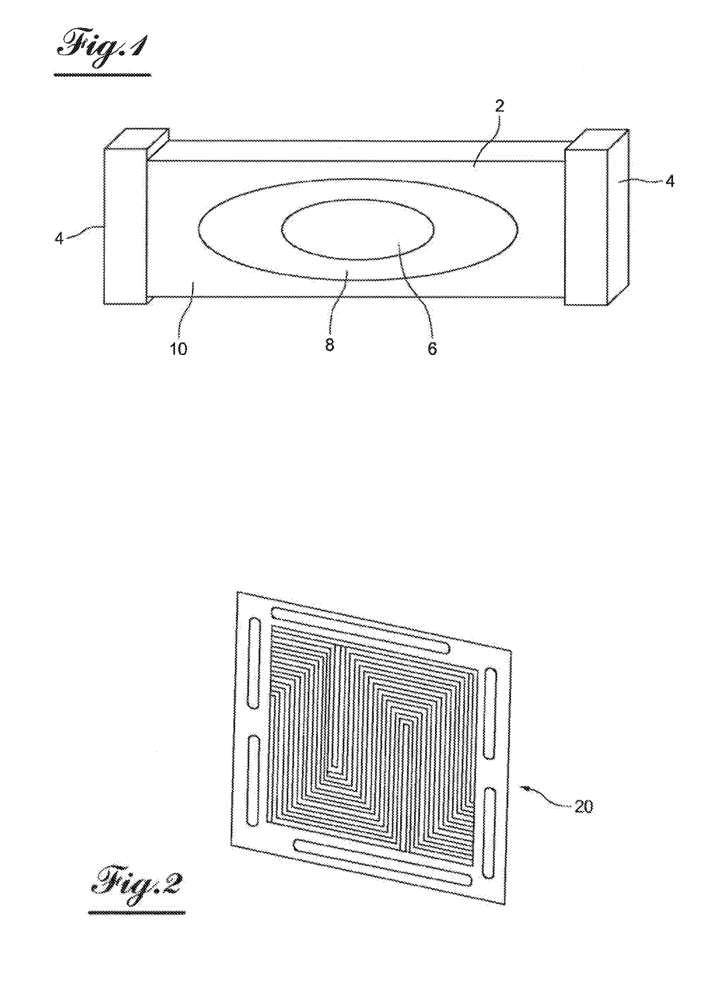

FIG. 1 shows a fuel-cell stack 1 comprising a series of cells 2 stacked with intermediate bipolar plates between said cells, bipolar plates each being passed through by a heat-transfer fluid of the cooling system that is managed by the management computer of the fuel-cell stack. The bipolar plates are identical and are supplied equally by the heat-transfer fluid.

The fuel-cell stack 1 includes, at each end, an end plate 4 that transmits the current to external connectors.

The fuel-cell stack 1 additionally includes an external circuit (not shown) for flowing heat-transfer fluid, comprising a flow pump and a fluid-air exchanger, to dissipate the calories taken from the cells 2 into the ambient air.

One can see that during the startup of the fuel-cell stack 1, different temperature zones are obtained, due in particular to the end plates 4 that make up heat masses that are slower to heat, and the heat exchangers of the cells with the ambient air, which are also higher at the ends.

A central zone 6 of the cells 2 remote from the end plates 4 has a higher temperature, an intermediate zone 8 surrounding a central zone has a medium temperature, and an external zone 10 better cooled by the ambient air and close to the cold end plates has a lower temperature.

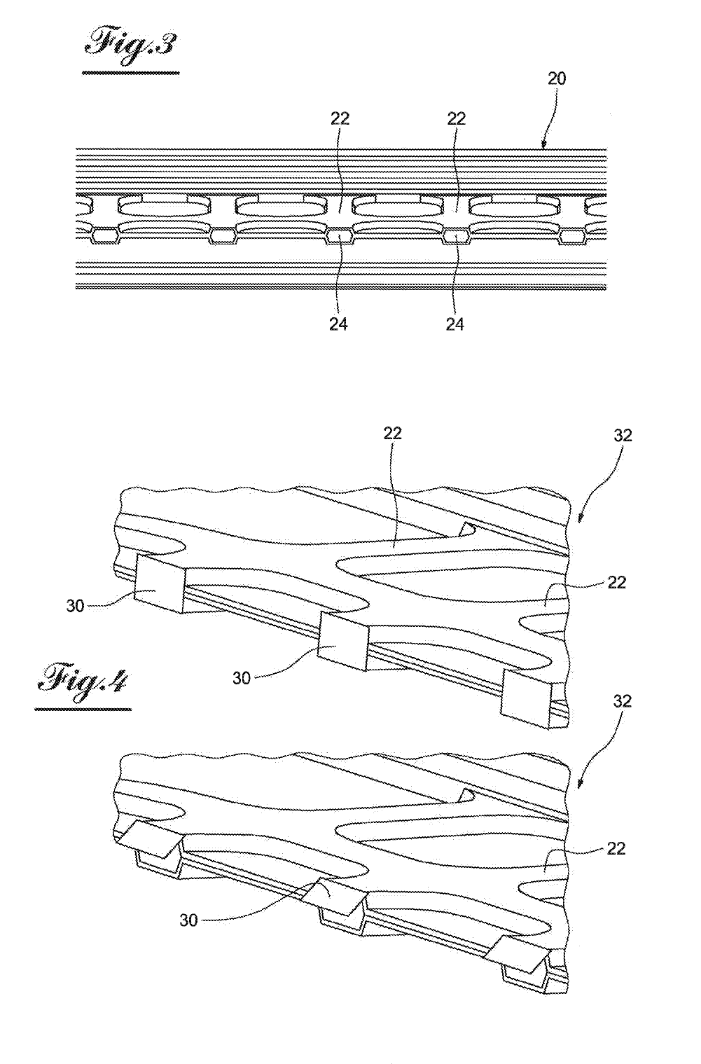

FIGS. 2 and 3 show a bipolar plate 20 in contact with the frontal surface of each cell alongside it, to transmit the current between said two cells while forming an electric pole of one of the cells, and the opposite pole of the other cell.

The bipolar plate 20 provides the cells alongside it, by a series of channels and piercings distributed on the faces in contact, with the reagents necessary for the electrochemical reactions.

The bipolar plate 20 additionally includes internal channels 22 formed in the thickness of said plate, and designed to receive the coolant that flows in those plates, said channels being provided over all of the plates of the fuel-cell stack 1.

For some of the bipolar plates 20, the inlets of all of the internal channels 22 are closed definitively by a closing means 24, for example including nipping of the metal forming the inlet of said channels, a drop of glue or a weld, so as to sealably close the internal volume formed by the set of channels. It is in particular possible to use a silicone seal to close the channels 22. Alternatively, only some of the fluid flow tunnels are sealed. Ideally, it is preferable to choose a sealing material similar to that used to seal the stack core. The sealing may also be done by nipping the end of the tunnels.

One thus obtains a volume of the channels 22 that can be put in a vacuum before closing, left in the open air, or filled beforehand with another gas or a material with a very low heat capacity, so as to obtain a bipolar plate 20 generally having a reduced heat capacity with respect to the same plate comprising its internal channels filled with the heat-transfer fluid.

One advantage of the bipolar plates 20 comprising a definitive closing means 24 is that they can easily be produced from standard plates comprising open channels 22, by adding a simple and cost-effective sealing operation to the end thereof.

Alternatively, it is possible to use bipolar plates not including channels, which are designed specifically for that purpose. In that case, it is possible to produce thinner bipolar plates, which comprise a lower metal mass and therefore reduced heat mass.

The bipolar plates 20 comprising closed channels 22 or an absence of channels are disposed in the coldest zones of the fuel-cell stack 1, for example alternating an increasingly large number of that type of plate when the zone is colder, so as to reduce the heat mass and the heat-transfer fluid flow rate in those zones to obtain a higher temperature, and procure better distribution of that temperature over the entire stack.

FIG. 4 alternatively shows another means for closing the internal channels 22 that is temporary and comprising, for each channel, a micro-valve 30 that can close automatically or in a controlled manner as shown in the upper part of the figure, or open as shown in the lower part, as a function of the temperature of the bipolar plate 32 and the fluid contained in its channels.

The micro-valves 30 may be made in different ways; for example, they may include a bimetal system that moves by blade expansion, the materials of the two blades and/or the assembly of the two blades and/or their shapes being chosen to cause the internal channel to open when the fluid reaches the flow authorization temperature of the fluid, a micro-engine thermostat that moves through the expansion of a gas capsule against the return force of a spring, thereby ensuring gradual opening of the channel from a closed position, or a micro-actuator, which may in particular use piezoelectric technology.

The bipolar plates 32 comprising temporary sealing means 30 for the channels 22 may, when the fuel-cell stack 1 is started up in cold weather, advantageously help regulate temperature in the coldest zones of the fuel-cell stack 1 located near the end plates 4, by limiting the flow rate of the heat-transfer fluid in those zones to allow a faster temperature increase.

Advantageously, the opening of the micro-valves 30 is done above 10° C., and no later than at a temperature slightly below the rated operating temperature of the fuel-cell stack, such as a temperature 20° C. below the rated temperature of the stack, for example a temperature of 60° C. when the stack must operate normally at a temperature of 80° C.

The closing must be done at a temperature lower than the opening temperature, to obtain a hysteresis that avoids an operating instability.

The micro-valve 30 is positioned outside the channel 24 at the inlet of the channel and mounted by one of its free edges secured along a corresponding edge of the channel delimiting the inlet thereof, for example by welding or forced crimping.

In its closed position, it opposes the flow inside the channel of the plate of the fluid driven by the external pump. When said micro-valve 30 is of the bimetal type, the component materials of its two blades will be chosen such that, up to a temperature authorizing the flow of the fluid (for example 10° C.-30° C.), the bimetal is flat and completely covers the inlet of the channel while pressing on the perimeters of the free edges of the channel defining the inlet (see FIG. 4, upper part) and once the fluid has reached that temperature, the bimetal deforms, for example by curving, and opens the inlet 24 of the channel 22 (FIG. 4, lower part).

Thus, as long as the temperature authorizing the flow of the heat-transfer fluid has not reached the minimum temperature (from 10° C.-30° C.), the plates that are provided with temporary sealing channels, i.e., generally the end plates, will have sealed channels and will not be passed through by the cold fluid or therefore cooled by the latter. They will be able to increase in temperature slowly in contact with the end cells while the fluid heats in contact with the central plates that are provided with open channels and that heat more quickly.

Additionally, when the temperature of the fluid only flowing in the central plates that heat up quickly exceeds the temperature authorizing the flow of the fluid, the bimetal micro-valve that heats from the outside of the channel deforms and opens the inlet of the channel so that the hotter fluid also flows into the end plates.

The new flow of the fluid in the end plates may cool it and cause its temperature to drop below the fluid flow authorization temperature. In that case, the bimetal micro-valves with which the end plates are equipped close and again seal the internal channels of said plates. Once the temperature of the fluid increases owing to its exclusive contact with the central plates and reaches the flow authorization temperature in the end plates, the bimetal micro-valves open again.

Afterwards, the stack gradually reaches the optimal operating temperature, which marks the end of the startup phase where the heat-transfer fluid ensures gradual heating of the stack and the beginning of normal operation of the stack where all of the channels are open and where the heat-transfer fluid performs a function cooling the plates.

The use of micro-valves in the form of bimetals makes it possible to subjugate the opening and closing of the automatic channel as a function of the temperature, without therefore requiring a temperature sensor, or electronic control unit controlling the opening or closing of the channel.

Furthermore, the integration of the bimetal into an existing plate with internal channels while securing the bimetal micro-valve on one of the edges of the inlet of the channel is extremely simple, quick and inexpensive.

This embodiment makes it possible to obtain automatic subjugation of the opening or closing of the channels of the end plate, at a lower cost.

With the embodiment where the micro-valve is a micro-engine thermostat or a micro-thermostat that closes by the expansion of a gas capsule, and gradually opens by compression of the gas, fluid is also gradually and increasingly introduced into the sealed channel when the fluid flow temperature is reached.

In the case of controlled opening of the sealing means 30 of the internal channels 22, for example comprising controlled micro-valves, it is advantageously possible to adjust the fluid flow rate by measuring the voltage of each cell or group of cells, so as to regulate the voltage to obtain a homogenous value for all of the cells, said voltage being directly related to the temperature of the concerned cells.

Furthermore, in the case of sealing by micro-valves or fluid micro-actuators, the opening/closing thereof (for those that operate in all-or-nothing mode) or their opening/closing level (for those with a controlled opening/closing level) may be controlled so as to keep the cell voltages homogenous in the entire stack, in particular at the ends. For example, when all of the bipolar plates have micro-actuators, upon startup at a negative temperature, every other plate must be sealed over the entire stack. Next, if the measurement of a cell voltage is below 20 my, for example, with respect to those of the center or with respect to the average voltage of the cells, the controller requires closure (if all-or-nothing control) or reduced opening of the micro-actuator (if opening level control) until the cell voltage reaches that of the center cells. Next, the controller manages the opening/closing or the degree of opening/closing so as to keep the cell voltages homogenous in the entire stack, in particular at the ends.

In general, it is therefore possible to achieve a regular or irregular distribution of the bipolar plates 20, 32 comprising the final or temporary sealing means, with a higher or lower density of those plates depending on whether one wishes to favor a faster temperature increase, or a greater total hot cooling capacity, respectively.

Typically, every other bipolar plate may be definitively sealed, in particular at the ends of the stack. Ideally, this proportion is a good compromise between the gain to accelerate the temperature increase during the cold solicitation phase and the preservation of the effectiveness of the hot cooling. The distribution of the seals may also be spatially optimized, i.e., there are more seals at the ends: ⅔ at the ends versus ½ at the center.

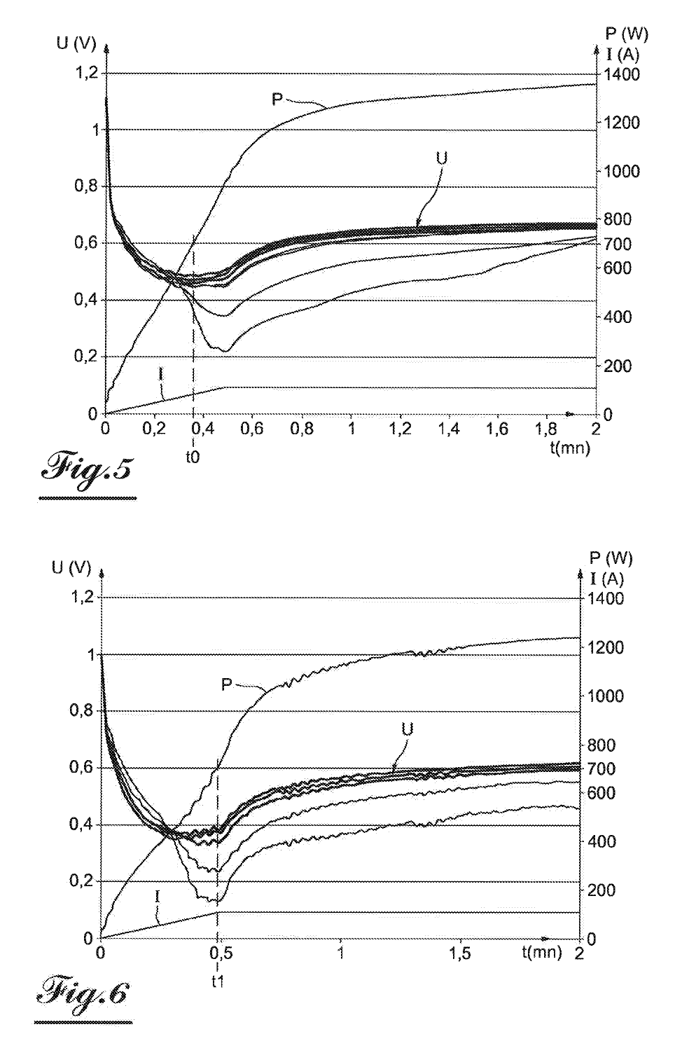

FIGS. 5 and 6 show a startup of a fuel-cell stack equipped with 19 cells, the time t being expressed in min, the discharged intensity I in A, the individual voltage of each cell U in V, and the total generated power P in W.

For FIG. 5, every other bipolar plate includes closed channels, and for FIG. 6, all of the bipolar plates have channels that remain open.

One can see that for FIG. 5, the power P of 700 W is reached at time t0 in 22 seconds, with minimum voltages U of the coldest cells positioned at the ends that remain above 0.2 V, whereas for FIG. 6, the power P of 700 W is reached at time t1 in 29 seconds, with minimum voltages U of the coldest cells dropping below 0.2 V. Additionally, the increase in the power P for FIG. 5 is more linear than for FIG. 6.

One thus obtains a fuel-cell stack locally having a reduced heat mass, or a reduced coolant flow, which accelerates at those points of temperature increase, which makes it possible to limit the needs of a connected preheating system, and to reduce the power of secondary energy storage devices that make it possible to deliver that energy while waiting for a temperature increase and availability of the fuel-cell stack.

The fuel-cell stack according to the invention can advantageously be used for a motor vehicle, and for all stationary applications such as a generator, for which a quick temperature increase is in particular desirable.

1. A fuel-cell stack including a stack of fuel cells comprising intermediate conductive bipolar plates wherein,
some of the bipolar plates include internal channels for flow of a heat-transfer fluid,
the internal channels are connected to a circuit of a cooling system, and
some of the bipolar plates include internal flow channels that are temporarily or permanently closed and thus are not in service.

2. The fuel-cell stack according to claim 1, wherein the bipolar plates comprising internal flow channels that are not in service are made from other bipolar plates in which an inlet of the internal flow channels is closed by permanent closing means or temporary closing means.

3. The fuel-cell stack according to claim 2, wherein the permanent closing means is selected from the group consisting of nipped metal forming the inlet of the internal flow channels, a drop of glue, and a weld.

4. The fuel-cell stack according to claim 3, wherein the internal flow channels that are not in service are evacuated, or filled with material having a low heat capacity.

5. (canceled)

6. The fuel-cell stack according to claim 1, wherein the bipolar plates comprising internal flow channels that are not in service include temporary closing means having at least one automatic operation means for operating as a function of temperature of that bipolar plate.

7. The fuel-cell stack according to claim 1, wherein the bipolar plates comprising internal flow channels that are not in service include temporary closing means that is controlled, by a micro-actuator.

8. The fuel-cell stack according to claim 1, including a greater density of bipolar plates comprising internal flow channels that are not in service.

9. A generator comprising a fuel-cell stack, according to claim 1.

10. An electric vehicle comprising a fuel-cell stack according to claim 1 and delivering electrical current used for traction.

11. A fuel-cell stack including a stack of fuel cells comprising intermediate conductive bipolar plates wherein,
some of the bipolar plates include internal channels for flow of a heat-transfer fluid,
the internal channels are connected to a circuit of a cooling system, and
some of the bipolar plates have no internal flow channels so that the bipolar plates have a reduced heat mass with respect to the bipolar plates including the internal flow channels.

12. The fuel-cell stack according to claim 11, wherein the bipolar plates that do not have internal flow channels have a low heat mass.

13. The fuel-cell stack according to claim 11, including a greater density of bipolar plates having no internal flow channels.

14. A generator comprising a fuel-cell stack according to claim 11.

15. An electric vehicle comprising a fuel-cell stack according to claim 11 and delivering electrical current used for traction.
